(19) United States
(12) Patent Application Publication
(10) Pub. No.: US 2019/0389075 A1
(43) Pub. Date: Dec. 26, 2019

(54) ROBOT SYSTEM AND ROBOT DIALOGUE METHOD

(71) Applicant: KAWASAKI JUKOGYO KABUSHIKI KAISHA, Kobe-shi, Hyogo (JP)

(72) Inventors: Yasuhiko HASHIMOTO, Kobe-shi (JP); Shogo HASEGAWA, Kakogawa-shi (JP); Masayuki WATANABE, Kobe-shi (JP); Yuichi OGITA, Kobe-shi (JP)

(73) Assignee: KAWASAKI JUKOGYO KABUSHIKI KAISHA, Kobe-shi, Hyogo (JP)

(21) Appl. No.: 16/483,827

(22) PCT Filed: Feb. 5, 2018
(86) PCT No.: PCT/JP2018/003848

§ 371 Date: Aug. 6, 2019

(30) Foreign Application Priority Data
Feb. 6, 2017 (JP) 2017-019832

(51) Int. Cl. B25J 13/00; G06F 3/16; G10L 13/047; G10L 15/22

(52) U.S. Cl. CPC B25J 13/003; G06F 3/16; B25J 13/006; G10L 15/22; G10L 13/047

(57) ABSTRACT

A robot system includes a work robot, a dialogue robot, and a communication device configured to communicate information between the dialogue robot and the work robot. The work robot includes a progress status reporting module configured to transmit to the dialogue robot, during the work, progress status information including operation process identification information that identifies currently-performed operation process, and a degree of progress of the operation process. The dialogue robot includes an utterance material database storing the operation process identification information, and utterance material data corresponding to the operation process so as to be associated with each other, and a language operation controlling module configured to read from the utterance material database the utterance material data corresponding to the received progress status information, generates robot utterance data based on the read utterance material data and the degree of progress, and outputs the generated robot utterance data to the language operation part.

### TECHNICAL FIELD

The present disclosure relates to a robot system and a robot dialogue method provided with a function of communicating between robots.

### BACKGROUND ART

Conventionally, dialogue robots which dialogue with a human are known. Patent Documents 1 and 2 disclose this kind of dialogue robots.

Patent Document 1 discloses a dialogue system provided with a plurality of dialogue robots. Utterance operation (language operation) and behavior (non-language operation) of each dialogue robot are controlled according to preset script. While the plurality of robots have a conversation according to the script, the robot occasionally asks a human who is a participant for something (asks the human a question or demands an agreement) to give the human who participates in the conversation with the plurality of robots a conversation feel equivalent to holding when having a conversation with other humans.

Moreover, Patent Document 2 discloses a dialogue system provided with a dialogue robot and a life support robot system. The life support robot system autonomously controls appliances (electrical household appliances provided with a communication function) which provide services for supporting human life. The dialogue robot acquires a user's living environment and information on his/her activities, and analyzes a user's situation, decides a service to be provided to the user based on the situation. Then, the dialogue robot asks with a voice message the user for making the user recognize the service to be provided. Then, when the dialogue robot determines based on a reply of the user that an attraction of the user into the conversation with the robot is successful, the robot transmits an execution demand of the service to the life robot support system or the appliance(s).

[Reference Document of Conventional Art]

### PATENT DOCUMENTS

[Patent Document 1] JP2016-133557A

[Patent Document 2] WO2005/086051A1

### DESCRIPTION OF THE DISCLOSURE

### Problems to be Solved by the Disclosure

The present inventors have examined a robot system which causes the dialogue robots described above to function as an interface between a work robot and a customer. In this robot system, the dialogue robot receives a request of a work from the customer, and a work robot performs the received request.

However, in the robot system described above, it is also assumed that the conversation feel established by the dialogue robot with the customer when receiving the request (i.e., a feel of the customer as participating in the conversation with the dialogue robot) may be spoiled, while the work robot performs the work, thereby boring the customer.

The present disclosure is made in view of the above situations, and it proposes a robot system and a robot dialogue method, which, also while a work robot performs a work requested from a human, produce in the human a feel of participating in the conversation with a dialogue robot and a work robot, and maintain the feel.

### SUMMARY OF THE DISCLOSURE

A robot system according to one aspect of the present disclosure includes a work robot having a robotic arm and an end effector attached to a hand part of the robotic arm, and configured to perform a work using the end effector based on a request of a human, a dialogue robot having a language operation part and a non-language operation part, and configured to perform a language operation and a non-language operation toward the work robot and the human, and a communication device configured to communicate information between the dialogue robot and the work robot. The work robot includes a progress status reporting module configured to transmit to the dialogue robot, during the work, progress status information including operation process identification information that identifies currently-performed operation process, and a degree of progress of the operation process. The dialogue robot includes an utterance material database storing the operation process identification information, and utterance material data corresponding to the operation process so as to be associated with each other, and a language operation controlling module configured to read from the utterance material database the utterance material data corresponding to the received progress status information, generates robot utterance data based on the read utterance material data and the degree of progress, and outputs the generated robot utterance data to the language operation part.

Moreover, a robot dialogue method according to another aspect of the present disclosure is a robot dialogue method performed by a work robot and a dialogue robot, the work robot including a robotic arm and an end effector attached to a hand part of the robotic arm, and configured to perform a work using the end effector based on a request of a human, and the dialogue robot having a language operation part and a non-language operation part, and configured to perform the language operation and the non-language operation toward the work robot and the human. The method includes causing the work robot to transmit to the dialogue robot, during the work, progress status information including operation process identification information that identifies a currently-performed operation process, and a degree of progress of the operation process, causing the dialogue robot to read utterance material data corresponding to the received progress status information from the utterance material database, the utterance material database storing the operation process identification information and the utterance material data corresponding to the operation process, so as to be associated with each other, and causing the dialogue robot to generate robot utterance data based on the read utterance material data and the degree of progress, and output the generated robot utterance data from the language operation part.

According to the robot system with the described configuration, while the work robot performs the work requested from the human, the dialogue robot performs the language operation toward the human and the work robot with the contents of utterance corresponding to the currently-performed operation process. That is, also while the work robot performs the work, the utterance (language operation) of the dialogue robot continues, and the utterance corresponds to the content and the situation of the work of the work robot. Therefore, during the work of the work robot, the human can feel like participating in the conversation with the dialogue robot and the work robot, and maintain the feel.

### Effect of the Disclosure

According to the present disclosure, the robot system can be realized, which, also while the work robot performs the work requested from the human, produces in the human the feel of participating in the conversation with the dialogue robot and the work robot, and maintains the feel.

### BRIEF DESCRIPTION OF DRAWINGS

FIG. 1 is a schematic view of a robot system according to one embodiment of the present disclosure.

FIG. 2 is a block diagram illustrating a configuration of a control system for a dialogue robot.

FIG. 3 is a block diagram illustrating a configuration of a control system for a work robot.

FIG. 4 is a plan view of a booth where the robot system is established.

FIG. 5 is a timing chart illustrating a flow of operation of the robot system.

FIG. 6 is a view illustrating a flow of the film pasting processing.

### MODE FOR CARRYING OUT THE DISCLOSURE

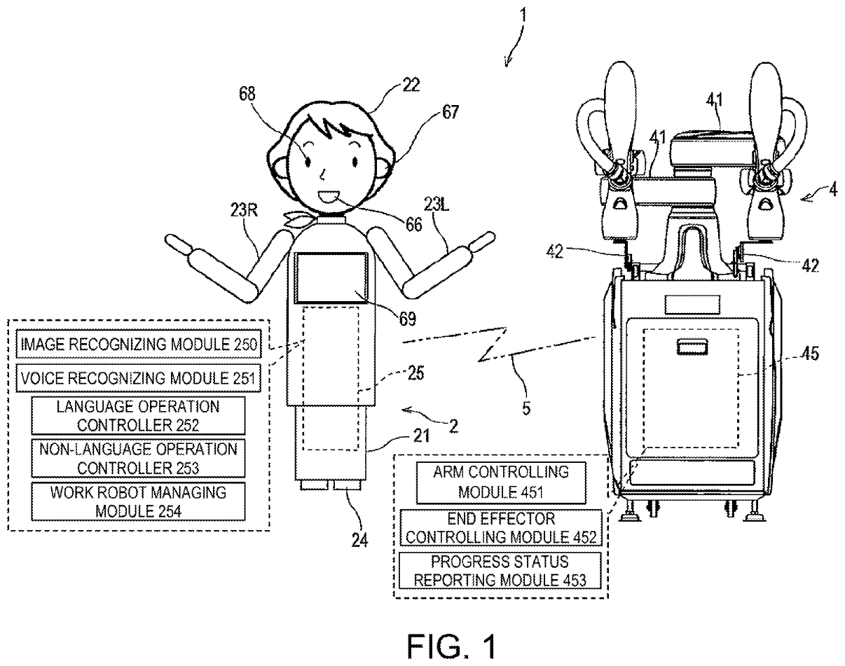

Next, one embodiment of the present disclosure will be described with reference to the drawings. FIG. 1 is a schematic view of a robot system 1 according to one embodiment of the present disclosure. The robot system 1 illustrated in FIG. 1 includes a dialogue robot 2 which has a conversation with a human 10, and a work robot 4 which performs a given work. The dialogue robot 2 and the work robot 4 are connected with each other by a communication device 5 wiredly or wirelessly so as to communicate information therebetween.

### [Dialogue Robot 2]

The dialogue robot 2 according to this embodiment is a humanoid robot for having a conversation with the human 10. However, the dialogue robot 2 is not limited to the humanoid robot, or may be a personified animal type robot and, thus, the appearance should not be limited.

The dialogue robot 2 includes a torso part 21, a head part 22 provided to an upper part of the torso part 21, left and right arm parts 23L and 23R provided to side parts of the torso part 21, and a traveling unit 24 provided to a lower part of the torso part 21. The head part 22, the arm parts 23L and 23R, and the traveling unit 24 of the dialogue robot 2 function as a “non-language operation part” of the dialogue robot 2. Note that, the non-language operation part of the dialogue robot 2 is not limited to the above configuration, and, for example, in a dialogue robot which can expose expression by eyes, nose, eyelids, etc., these expression forming elements also correspond to the non-language operation part.

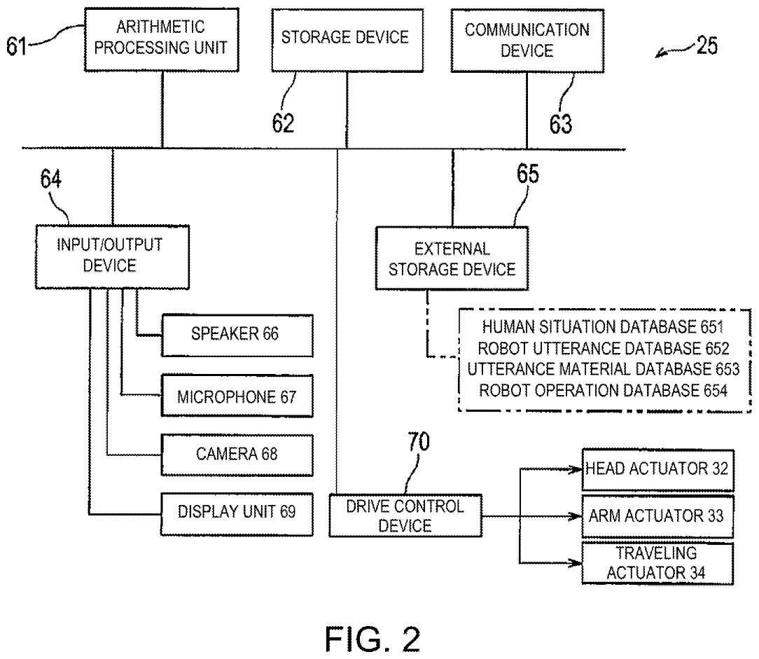

The head part 22 is connected with the torso part 21 through a neck joint so as to be rotatable and bendable. The arm parts 23L and 23R are rotatably connected to the torso part 21 through shoulder joints. Each of the arm parts 23L and 23R has an upper arm, a lower arm, and a hand. The upper arm and the lower arm are connected with each other through an elbow joint, and the lower arm and the hand are connected with each other through a wrist joint. The dialogue robot 2 includes a head actuator 32 for operating the head part 22, and an arm actuator 33 for operating the arm parts 23L and 23R, and a traveling actuator 34 for operating the traveling unit 24 (see FIG. 2). Each of the actuators 32, 33, and 34 are provided with, for example, at least one actuator, such as an electric motor. Each of the actuators 32, 33, and 34 operates in response to a control by a controller 25.

The dialogue robot 2 includes a camera 68, a microphone 67 and a speaker 66 built inside the head part 22, and the display unit 69 attached to the torso part 21. The speaker 66 and the display unit 69 function as a “language operation part” of the dialogue robot 2.

The controller 25 which governs the language operation and the non-language operation of the dialogue robot 2 is accommodated in the torso part 21 of the dialogue robot 2. Note that the “language operation” of the dialogue robot 2 means a communication transmitting operation by operation of the language operation part of the dialogue robot 2 (i.e., sound emitted from the speaker 66, or character(s) displayed on the display unit 69). Moreover, the “non-language operation” of the dialogue robot 2 means a communication transmitting operation by operation of the non-language operation part of the dialogue robot 2 (i.e., a change in the appearance of the dialogue robot 2 by operation of the head part 22, the arm parts 23L and 23R, and the traveling unit 24).

FIG. 2 is a block diagram illustrating a configuration of a control system of the dialogue robot 2. As illustrated in FIG. 2, the controller 25 of the dialogue robot 2 is a so-called computer, and includes an arithmetic processing unit (processor) 61, such as a CPU, a storage device 62, such as a ROM and/or a RAM, a communication device 63, an input/output device 64, an external storage device 65, and a drive control device 70. The storage device 62 stores a program executed by the arithmetic processing unit 61, various fixed data, etc. The arithmetic processing unit 61 communicates data with the controller 45 of the work robot 4 wirelessly or wiredly through the communication device 63. The arithmetic processing unit 61 also accepts inputs of detection signals from various sensors, and outputs various control signals, through the input/output device 64. The input/output device 64 is connected with the speaker 66, the microphone 67, the camera 68, the display unit 69, etc. The drive control device 70 operates the actuators 32, 33, and 34. The arithmetic processing unit 61 performs storing and reading of the data to/from the external storage device 65. Various databases (described later) may be established in the external storage device 65.

The controller 25 functions as an image recognizing module 250, a voice recognizing module 251, a language operation controlling module 252, a non-language operation controlling module 253, and a work robot managing module 254. These functions are realized by the arithmetic processing unit 61 reading and executing software, such as the program stored in the storage device 62. Note that the controller 25 may execute each processing by a centralized control of a sole computer, or may execute each processing by a distributed control of a plurality of collaborating computers. Moreover, the controller 25 may be comprised of a microcontroller, a programmable logic controller (PLC), etc.

The image recognizing module 250 detects the existence of the human 10 by acquiring an image (video) captured by the camera 68 and carrying out image processing. The image recognizing module 250 also acquires the image (video) captured by the camera 68, analyzes movement of the human 10, behavior, expression, etc. of the human 10, and generates human movement data.

The voice recognizing module 251 picks up sound or voice uttered by the human 10 with the microphone 67, recognizes the content of the voice data, and generates human utterance data.

The language operation controlling module 252 analyzes a situation of the human 10 based on the script data stored beforehand, the human movement data, the human utterance data, etc., and generates the robot utterance data based on the analyzed situation. The language operation controlling module 252 outputs the generated robot utterance data to the language operation part of the dialogue robot 2 (the speaker 66, or the speaker 66 and the display unit 69). Thus, the dialogue robot 2 performs the language operation.

In the above, when the language operation controlling module 252 analyzes the situation of the human 10, the language operation controlling module 252 may associate human movement data and human utterance data, with a human situation, and store it in human situation database 651 beforehand, so as to analyze the situation of the human 10 using the information accumulated in the human situation database 651. Moreover, in the above, when the language operation controlling module 252 generates the robot utterance data, the script data, the human situation, and the robot utterance data may be stored in robot utterance database 652 beforehand so as to be associated with each other, and the robot utterance data may be generated using the information accumulated in the robot utterance database 652.

The language operation controlling module 252 also receives progress status information (described later) from the work robot 4, generates the robot utterance data, and outputs the robot utterance data to the language operation part of the dialogue robot 2 (the speaker 66, or the speaker 66 and the display unit 69). Thus, the dialogue robot 2 performs the language operation.

In the above, the progress status information includes operation process identification information for identifying the operation process which the work robot 4 is currently performing, and a degree of progress of the operation process. When the language operation controlling module 252 generates the robot utterance data, the operation process identification information, its operation process, and corresponding utterance material data are stored in utterance material database 653 beforehand so as to be associated with each other, and the utterance material data corresponding to the progress status information received is read from the utterance material database 653. Then, the language operation controlling module 252 generates the robot utterance data based on the read utterance material data and the received degree of progress.

When the dialogue robot 2 performs the language operation, the non-language operation controlling module 253 generates the robot operation data so as to perform the non-language operation corresponding to the language operation. The non-language operation controlling module 253 outputs the generated robot operation data to the drive control device 70, and, thereby, the dialogue robot 2 performs the non-language operation based on the robot operation data.

The non-language operation corresponding to the language operation is behavior of the dialogue robot 2 corresponding to the content of the language operation of the dialogue robot 2. For example, when the dialogue robot 2 pronounces the name of an object, pointing to the object by the arm parts 23L and 23R, or turning the head part 22 to the object corresponds to the non-language operation. Moreover, for example, when the dialogue robot 2 pronounces gratitude, uniting both hands or hanging down the head part 22 corresponds to the non-language operation.

In the above, when the non-language operation controlling module 253 generates the robot operation data, the robot utterance data, and the robot operation data for causing the dialogue robot 2 to perform the non-language operation corresponding to the language operation caused by the robot utterance data may be stored beforehand in robot operation database 654 so as to be associated with each other. The robot operation data corresponding to the robot utterance data may be read from the information accumulated in the robot operation database 654 to generate the robot utterance data.

The work robot managing module 254 transmits a processing start signal to the work robot 4 according to the script data stored beforehand. Moreover, the work robot managing module 254 transmits a progress check signal (described later) to the work robot 4 at an arbitrary timing between the transmission of the processing start signal to the work robot 4 and a reception of an end signal of the processing from the work robot 4.

[Work Robot 4]

The work robot 4 includes at least one articulated robotic arm 41, an end effector 42 which performs a work by being attached to the hand part of the robotic arm 41, and a controller 45 which governs operations of the robotic arm 41 and the end effector 42. The work robot 4 according to this embodiment is a dual-arm robot having two robotic arms 41 which collaboratively perform a work. However, the work robot 4 is not limited to this embodiment, and it may be a single-arm robot having one robotic arm 41, or may be a multi-arm robot having a plurality of, three or more robotic arms 41.

The robotic arm 41 is a horizontal articulated robotic arm, and has a plurality of links connected in series through joints. However, the robotic arm 41 is not limited to this embodiment, and may be of a vertical articulated type.

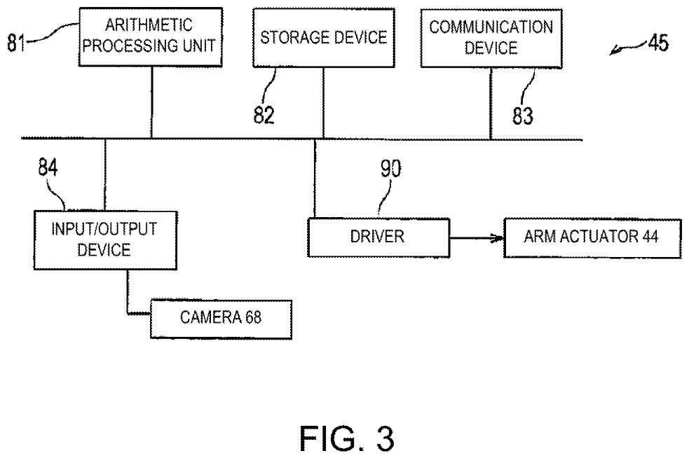

The robotic arm 41 has an arm actuator 44 for operating the robotic arm 41 (see FIG. 3). The arm actuator 44 includes, for example, electric motors as drive sources provided to the respective joints, and gear mechanisms which transmit the rotational outputs of the electric motors to the respective links. The arm actuator operates in response to a control by the controller 45.

The end effector 42 attached to the hand part of the robotic arm 41 may be selected according to the content of the work performed by the work robot 4. Moreover, the work robot 4 may replace the end effector 42 with another one for every process of the work.

FIG. 3 is a block diagram illustrating a configuration of a control system of the work robot 4. As illustrated in FIG. 3, the controller 45 of the work robot 4 is a so-called computer, and includes an arithmetic processing unit (processor) 81, such as a CPU, a storage device 82, such as a ROM and/or RAM, a communication device 83, and an input/output device 84. The storage device 82 stores a program to be executed by the arithmetic processing unit 81, various fixed data, etc. The arithmetic processing unit 81 communicates data with the controller 25 of the dialogue robot 2 wirelessly or wiredly through the communication device 83. The arithmetic processing unit 81 also accepts inputs of detection signals from various sensors provided to the camera 88 and the arm actuator 44, and outputs various control signals, through the input/output device 84. Moreover, the arithmetic processing unit 81 is connected with a driver 90 which operates an actuator included in the arm actuator 44.

The controller 45 functions as an arm controlling module 451, an end effector controlling module 452, a progress status reporting module 453, etc. These functions are realized by the arithmetic processing unit 81 reading and executing software, such as the program stored in the storage device 82, according to the script data stored beforehand Note that the controller 45 may execute each processing by a centralized control of a sole computer, or may execute each processing by a distributed control of a plurality of collaborating computers. Moreover, the controller 45 may be comprised of a microcontroller, a programmable logic controller (PLC), etc.

The arm controlling module 451 operates the robotic arm 41 based on teaching data stored beforehand. Specifically, the arm controlling module 451 generates a positional command based on the teaching data, and detection information from various sensors provided to the arm actuator 44, and outputs it to the driver 90. The driver 90 operates each actuator included in the arm actuator 44 according to the positional command.

The end effector controlling module 452 operates the end effector 42 based on operation data stored beforehand. The end effector 42 is comprised of, for example, at least one actuator among an electric motor, an air cylinder, an electromagnetic valve, etc., and the end effector controlling module 452 operates the actuator(s) according to the operation of the robotic arm 41.

The progress status reporting module 453 generates the progress status information during the work of the work robot 4, and transmits it to the dialogue robot 2. The progress status information includes at least the operation process identification information for identifying the currently-performed operation process, and the degree of progress of the operation process, such as abnormal or normal of the processing and the progress. Note that the generation and the transmission of the progress status information may be performed to a given timing, such as a timing at which the progress check signal (described later) is acquired from the dialogue robot 2, a timing of a start and an end of each operation process included in the processing, etc.

### [Flow of Operation of Robot System 1]

Here, one example of operation of the robot system 1 of the above configuration is described. In this example, the work robot 4 performs a work of pasting a protection film on a liquid crystal display part of the smartphone (a tablet type communication terminal). However, the content of the work performed by the work robot 4, and the contents of the language operation and the non-language operation of the dialogue robot 2 are not limited to this example.

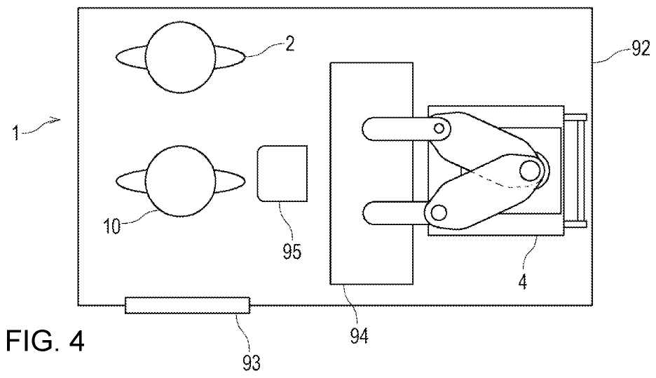

FIG. 4 is a plan view of a booth 92 where the robot system 1 is established. As illustrated in FIG. 4, the dialogue robot 2 and the work robot 4 are disposed within one booth 92. As seen by the human 10 who enters into the booth 92 from an entrance 93, the dialogue robot 2 is located at the position of 12 o'clock, and the work robot 4 is located at the position of 3 o'clock. A workbench 94 is provided in front of the work robot 4, and the workbench 94 divides the space between the human 10 and the work robot 4. A chair 95 is placed in front of the work robot 4, having the workbench 94 therebetween.

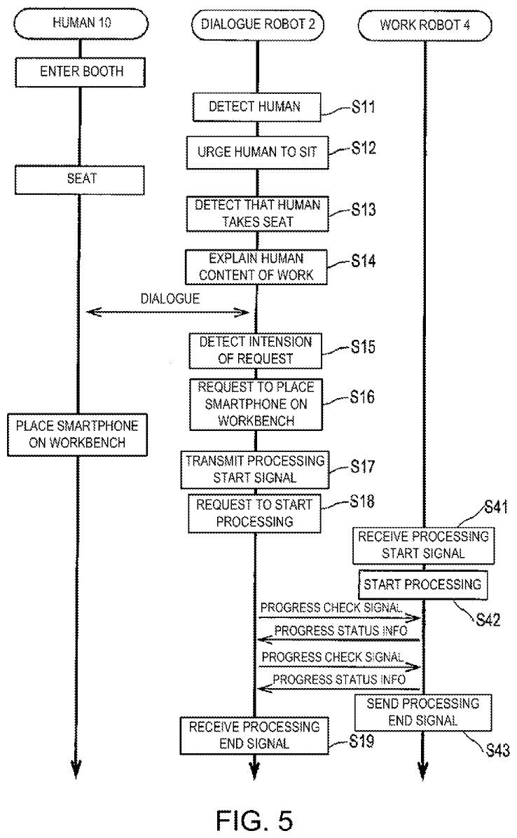

FIG. 5 is a timing chart illustrating a flow of operation of the robot system 1. As illustrated in FIG. 5, the work robot 4 in a standby state waits for the processing start signal from the dialogue robot 2. On the other hand, the dialogue robot 2 in a standby state waits for the human 10 who visits the booth 92. The dialogue robot 2 monitors the captured image of the camera 68, and detects the human 10 who visits the booth 92 based on the captured image (Step S11).

When the human 10 visits the booth 92, the dialogue robot 2 performs the language operation (utterance) “Welcome. Please sit on the chair.” and the non-language operation (gesture) toward the human 10 to urge the human 10 to sit (Step S12).

When the dialogue robot 2 detects that the human 10 takes the seat based on the captured image (Step S13), it performs the language operation “In this booth, a service for pasting a protection sticker on your smartphone is provided.” and the non-language operation toward the human 10, to explain to the human 10 the content of the work to be performed by the work robot 4 (Step S14).

When the dialogue robot 2 analyzes voice of the human 10 and the captured image, and detects the intension of the human 10 of a request of the work (Step S15), it performs the language operation “Alright then, please place your smartphone on the workbench.” and the non-language operation toward the human 10, to urge the human 10 to place the smartphone on the workbench 94 (Step S16).

Further, the dialogue robot 2 transmits the processing start signal toward the work robot 4 (Step S17). When the dialogue robot 2 transmits the processing start signal, it performs toward the work robot 4 the language operation “Mr. Robot, please begin the preparation.” and performs the non-language operation in which the dialogue robot 2 turns the face toward the work robot 4, shakes the hand(s) to urge the start of processing, etc. (Step S18).

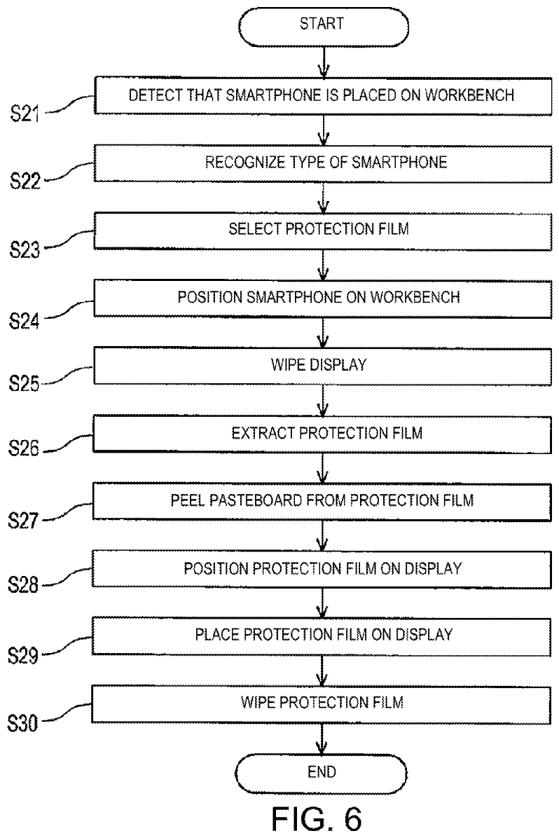

The work robot 4 which acquired the processing start signal (Step S41) starts the film pasting processing (Step S42). FIG. 6 is a view illustrating a flow of the film pasting processing. As illustrated in FIG. 6, in the film pasting processing, the work robot 4 detects that the smartphone is placed at the given position of the workbench 94 (Step S21), recognizes the type of the smartphone (Step S22), and selects a suitable protection film for the type of the smartphone from films in a film holder (Step S23).

The work robot 4 positions the smartphone on the workbench 94 (Step S24), wipes a display part of the smartphone (Step S25), and extracts a protection film from the film holder (Step S26), peels pasteboard from the protection film (Step S27), positions the protection film on the display part of the smartphone (Step S28), places the protection film on the display part of the smartphone (Step S29), and wipes the protection film (Step S30).

In the film pasting processing, the work robot 4 performs a series of processes at Steps S21-S30. After the film pasting processing is finished, the work robot 4 transmits the processing end signal to the dialogue robot 2 (Step S43).

The dialogue robot 2 transmits the progress check signal to the work robot 4 at an arbitrary timing, while the work robot 4 performs the film pasting processing. For example, the dialogue robots 2 may transmit the progress check signal to the work robot 4 at given time intervals, such as for every 30 seconds. The work robot 4 transmits the progress status information to the dialogue robot 2, using that the progress check signal is acquired as a trigger. Note that the work robot 4 may transmit the progress status information to the dialogue robot 2 at the timing of the start and/or the end of the operation process, regardless of the existence of the progress check signal from the dialogue robot 2.

When the progress status information is received from the work robot 4, the dialogue robot 2 performs the language operation and the non-language operation corresponding to the operation process currently performed by the work robot 4. Note that the dialogue robot 2 may determine not to perform the language operation and the non-language operation based on the content of the progress status information, the timings and intervals of the last language operation and non-language operation, the situation of the human 10, etc.

For example, at a timing where the work robot 4 finished the selection process of the protection film (Step S23), the dialogue robot 2 performs the language operation “Alright then, Mr. Robot. Please start.” and the non-language operation toward the work robot 4.

Moreover, for example, at an arbitrary timing while the work robot 4 performs the processes between the positioning process of the smartphone (Step S24) and the peeling process of the pasteboard (Step S27), the dialogue robot 2 performs the language operation “It is exciting if he can paste the film well.” and the non-language operation toward the human 10. Further, when the dialogue robot 2 asks the question to the human 10 and the human 10 then answers to the question, the dialogue robot 2 may answer to the utterance of the human 10.

Moreover, for example at a timing where the work robot 4 performs the protection film wiping process (Step S30), the dialogue robot 2 performs the language operation “It will be done soon.” and the non-language operation toward the work robot 4 and/or the human 10.

As described above, while the work robot 4 performs the work silently, the dialogue robot 2 speaks to the work robot 4 or has a conversation with the human 10. Therefore, the human 10 is not bored during the work of the work robot 4. Moreover, since the dialogue robot 2 utters and gestures toward the work robot 4 which performs the work, the work robot 4 joins the dialogue members who were only the dialogue robot 2 and the human 10 when the human 10 visited.

As described above, the robot system 1 of this embodiment includes the work robot 4 which has the robotic arm 41 and the end effector 42 attached to the hand part of the robotic arm 41, and performs the work using the end effector 42 based on the request of the human 10, the dialogue robot 2 which has the language operation part and the non-language operation part, and performs the language operation and the non-language operation toward the work robot 4 and the human 10, and the communication device 5 which communicates the information between the dialogue robot 2 and the work robot 4. Then, the work robot 4 has the progress status reporting module 453 which transmits to the dialogue robot 2, during the work, the progress status information including the operation process identification information for identifying the currently-performed operation process, and the degree of progress of the operation process. Moreover, the dialogue robot 2 includes the utterance material database 653 which stores the operation process identification information and the utterance material data corresponding to the operation process so as to be associated with each other, and the language operation controlling module 252 which reads the utterance material data corresponding to the received progress status information from the utterance material database 653, generates the robot utterance data based on the read utterance material data and the degree of progress, and outputs the generated robot utterance data to the language operation part.

Moreover, the robot dialogue method of this embodiment is performed by the work robot 4 which includes the robotic arm 41 and the end effector 42 attached to the hand part of the robotic arm 41, and performs the work using the end effector 42 based on the request of the human 10, and the dialogue robot 2 which includes the language operation part and the non-language operation part, and performs the language operation and the non-language operation toward the work robot 4 and the human 10. In this robot dialogue method, the work robot 4 transmits to the dialogue robot 2, during the work, the progress status information including the operation process identification information for identifying the currently-performed operation process, and the degree of progress of the operation process, and the dialogue robot 2 reads the utterance material data corresponding to the received progress status information from the utterance material database 653 which stores the operation process identification information and the utterance material data corresponding to the operation process so as to be associated with each other, generates the robot utterance data based on the read utterance material data and degree of progress, and outputs the generated robot utterance data from the language operation part.

In the above, the dialogue robot 2 may include the work robot managing module 254 which transmits, during the work of the work robot 4, the progress check signal to the work robot 4, and the work robot 4 may transmit the progress status information to the dialogue robot 2, using that the progress check signal is received as the trigger.

Alternatively, in the above, the work robot 4 may transmit the progress status information to the dialogue robot 2 at the timing of the start and/or the end of the operation process.

According to the robot system 1 and the robot dialogue method described above, while the work robot 4 performs the work requested from the human 10, the dialogue robot 2 performs the language operation toward the human and the work robot with the contents of utterance corresponding to the currently-performed operation process. That is, also while the work robot 4 performs the work, the utterance (language operation) of the dialogue robot 2 continues, and the utterance corresponds to the content and the situation of the work of the work robot 4. Therefore, during the work of the work robot 4, the human 10 can feel like participating in the conversation with the dialogue robot 2 and the work robot 4 (conversation feel), and maintain the feel.

Moreover, in the robot system 1 according to this embodiment, the dialogue robot 2 described above includes the robot operation database 654 which stores the robot utterance data, and the robot operation data for causing the dialogue robot to perform the non-language operation corresponding to the language operation caused by the robot utterance data, so as to be associated with each other, and the non-language operation controlling module 253 which reads the robot operation data corresponding to the generated robot utterance data from the robot operation database 654, and outputs the read robot operation data to the non-language operation part.

Similarly, in the robot dialogue method according to this embodiment, the dialogue robot 2 outputs from the non-language operation part the robot operation data for causing the dialogue robot 2 to perform the non-language operation corresponding to the language operation caused by the generated robot utterance data.

Thus, the dialogue robot 2 performs the non-language operation (i.e., behavior) corresponding to the language operation in association with the language operation. The human 10 who looked at the non-language operation of the dialogue robot 2 can feel the conversation feel with the robots 2 and 4, which is deeper than the case where the dialogue robot 2 only performs the language operation.

Moreover, in the robot system 1 and the robot dialogue method according to this embodiment, the dialogue robot 2 has the conversation with the human 10 according to given script data by performing the language operation and the non-language operation toward the human 10, analyzes the content of the conversation to acquire the request from the human 10, transmits the processing start signal of the work to the work robot 4 based on the request, and performs the language operation and the non-language operation toward the work robot 4.

Thus, since the dialogue robot 2 accepts the work to be performed by the work robot 4, the human 10 can have the feel of participating in the conversation with the dialogue robot 2 from the stage before the work robot 4 performs the work. When the dialogue robot 2 transmits the processing start signal to the work robot 4, since the dialogue robot 2 performs the language operation and the non-language operation to the work robot 4, the human 10 who is looking at the operations can have the feel that the work robot 4 joined the earlier conversation with the dialogue robot 2.

Although the suitable embodiment of the present disclosure is described above, what changed the details of the concrete structures and/or functions of the above embodiment may be encompassed by the present disclosure, without departing from the spirit of the present disclosure.

### DESCRIPTION OF REFERENCE CHARACTERS

2: Dialogue Robot
4: Work Robot
5: Communication Device
10: Human
21: Torso Part
22: Head Part
23L, 23R: Arm Part
24: Traveling Unit
25: Controller
250: Image Recognizing Module
251: Voice Recognizing Module
252: Language Operation Controlling Module
253: Non-language Operation Controlling Module
254: Work Robot Managing Module
32: Head Actuator
33: Arm Actuator
34: Traveling Actuator
41: Robotic Arm
42: End Effector
44: Arm Actuator
45: Controller
451: Arm Controlling Module
452: End Effector Controlling Module
453: Progress Status Reporting Module
61: Arithmetic Processing Unit
62: Storage Device
63: Communication Device
64: Input/output Device
65: External Storage Device
651: Human Situation Database
652: Robot Utterance Database
653: Utterance Material Database
654: Robot Operation Database
66: Speaker
67: Microphone
68: Camera
69: Display
70: Drive Control Device
81: Arithmetic Processing Unit
82: Storage Device
83: Communication Device
84: Input/output Device
88: Camera
90: Driver
92: Booth
93: Entrance
94: Workbench
95: Chair

1. A robot system, comprising:
a work robot having a robotic arm and an end effector attached to a hand part of the robotic arm, and configured to perform a work using the end effector based on a request of a human;
a dialogue robot having a language operation part and a non-language operation part, and configured to perform a language operation and a non-language operation toward the work robot and the human; and
a communication device configured to communicate information between the dialogue robot and the work robot,
wherein the work robot includes a progress status reporting module configured to transmit to the dialogue robot, during the work, progress status information including operation process identification information that identifies currently-performed operation process, and a degree of progress of the operation process, and
wherein the dialogue robot includes an utterance material database storing the operation process identification information, and utterance material data corresponding to the operation process so as to be associated with each other, and a language operation controlling module configured to read from the utterance material database the utterance material data corresponding to the received progress status information, generate robot utterance data based on the read utterance material data and the degree of progress, and output the generated robot utterance data to the language operation part.

2. The robot system of claim 1, wherein the dialogue robot further includes:
a robot operation database configured to store the robot utterance data, and the robot operation data that causes the dialogue robot to perform the non-language operation corresponding to the language operation caused by the robot utterance data, so as to be associated with each other; and
a non-language operation controlling module configured to read the robot operation data corresponding to the generated robot utterance data from the robot operation database, and output the read robot operation data to the non-language operation part.

3. The robot system of claim 1, wherein the dialogue robot includes a work robot managing module configured to transmit, during the work of the work robot, a progress check signal to the work robot, and
wherein the work robot transmits the progress status information to the dialogue robot, using a reception of the progress check signal as a trigger.

4. The robot system of claim 1, wherein the work robot transmits the progress status information to the dialogue robot at a timing of a start and/or an end of the operation process.

5. The robot system of claim 1, wherein the dialogue robot has a conversation with the human according to given script data by performing the language operation and the non-language operation toward the human, and
wherein the dialogue robot analyzes content of the conversation to acquire the request from the human, transmits a processing start signal of the work to the work robot based on the request, and performs the language operation and the non-language operation toward the work robot.

6. A robot dialogue method, performed by a work robot and a dialogue robot, the work robot including a robotic arm and an end effector attached to a hand part of the robotic arm, and configured to perform a work using the end effector based on a request of a human, and the dialogue robot having a language operation part and a non-language operation part, and configured to perform the language operation and the non-language operation toward the work robot and the human, the method comprising the steps of:
causing the work robot to transmit to the dialogue robot, during the work, progress status information including operation process identification information that identifies a currently-performed operation process, and a degree of progress of the operation process;
causing the dialogue robot to read utterance material data corresponding to the received progress status information from the utterance material database, the utterance material database storing the operation process identification information and the utterance material data corresponding to the operation process, so as to be associated with each other; and
causing the dialogue robot to generate robot utterance data based on the read utterance material data and the degree of progress, and output the generated robot utterance data from the language operation part.

7. The robot dialogue method of claim 6, wherein the dialogue robot outputs robot operation data that causes the dialogue robot to perform non-language operation corresponding to language operation caused by the generated robot utterance data from the non-language operation part.

8. The robot dialogue method of claim 6, wherein the dialogue robot transmits, during the work of the work robot, a progress check signal to the work robot, and
wherein the work robot transmits the progress status information to the dialogue robot, using a reception of the progress check signal as a trigger.

9. The robot dialogue method of claim 6, wherein the work robot transmits the progress status information to the dialogue robot at a timing of a start and/or an end of the operation process.

10. The robot dialogue method of claim 6, wherein the dialogue robot has a conversation with the human according to given script data by performing the language operation and the non-language operation toward the human, and
wherein the dialogue robot analyzes content of the conversation to acquire a request from the human, transmits a processing start signal of the work to the work robot based on the request, and performs the language operation and the non-language operation toward the work robot.
